(19) United States
(12) Patent Application Publication
(10) Pub. No.: US 2025/0328954 A1
(43) Pub. Date: Oct. 23, 2025

(54) Technologies for Real-Time Payments Monitoring

(71) Applicant: The PNC Financial Services Group, Inc., Pittsburgh, PA (US)

(72) Inventors: Venkataraman Muthuramalingam, Farmers Branch, TX (US); Devesh Kumar Pandey, Cleveland, OH (US)

(21) Appl. No.: 19/034,725

(22) Filed: Jan. 23, 2025

Related U.S. Application Data
(60) Provisional application No. 63/636,922, filed on Apr. 22, 2024.

(51) Int. Cl. G06Q 40/02

(52) U.S. Cl. CPC G06Q 40/02

(57) ABSTRACT

Technologies for real-time payments monitoring include a compute device. The compute device includes circuitry configured to obtain, by subscribing to at least one topic of an event streaming system associated with a predefined set of payment systems or financial products, financial transaction data indicative of financial transactions associated with one or more accounts of a financial institution. The circuitry may also be configured to analyze the obtained financial transaction data to determine a present condition associated with the financial transactions. Additionally the circuitry may be configured to provide result data indicative of the present condition to a user for review.

### RELATED APPLICATIONS

This application claims the benefit of U.S. Provisional Application No. 63/636,922 filed Apr. 22, 2024 for “Technologies for Real-Time Payments Monitoring,” which is hereby incorporated by reference in its entirety.

### BACKGROUND

Sophisticated financial institutions (e.g., banks) may be involved in financial transactions associated with a great variety of payment systems (e.g., channels), such as online banking (e.g., through a website) and mobile banking (e.g., through an application executed on a portable compute device), transactions initiated through interactive voice response (IVR) systems, in-person interactions at branch offices, or others. Those transactions may be initiated from anywhere in the world through a vast data network and may pertain to any of a number of financial products (e.g., retail or corporate loans, lines of credit, etc.) provided to customers by the financial institution. Given this level of complexity and scale, monitoring transactions to identify and address potential issues as they are developing, rather than after they have already incurred costly damage (e.g., financial, technical, reputational, etc.), is a significant technical problem.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for continually monitoring financial transactions associated with a financial institution to enable efficient detection of anomalies;

FIG. 2 is a simplified block diagram of at least one embodiment of a compute device of the system of FIG. 1;

FIGS. 3-7 are simplified block diagrams of at least one embodiment of a method for monitoring financial transactions that may be executed by the system of FIG. 1;

FIGS. 8-10 are diagrams of embodiments of data flows that may be utilized by the system of FIG. 1 in monitoring financial transactions; and

FIGS. 11-15 are diagrams of embodiments of user interfaces that may be produced by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

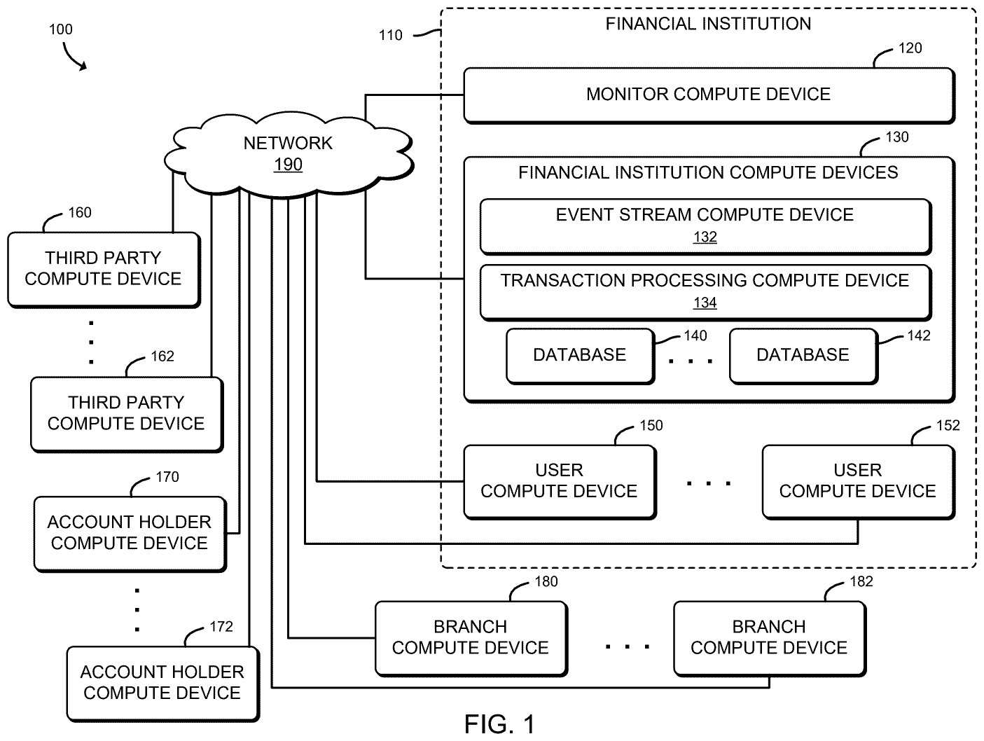

Referring now to FIG. 1, a system 100 for continually monitoring financial transactions (e.g., payments) associated with a financial institution 110 includes, in the illustrative embodiment, a monitor compute device 120 communicatively connected to a set of one or more financial institution compute devices 130. The financial institution compute devices 130 include an event stream compute device 132 which receives, from other compute devices (e.g., one or more transaction processing compute devices 134), sets of data pertaining to the operations of the financial institution 110, including financial transactions (e.g., payments) occurring in connection with one or more accounts associated with the financial institution 110. The financial institution compute devices 130 may also support operations of one or more call centers and/or interactive voice response (IVR) systems on behalf of the financial institution 110. In operation, the compute devices 120, 130 may utilize databases 140, 142 which may enable storage and retrieval of data (e.g., customer account identifiers, data indicative of financial products, historical records of financial transactions, etc.), on as requested basis, to enable the financial institution 110 to carry out operations described herein.

Financial transactions associated with the financial institution 110 may be initiated or otherwise facilitated by third party compute devices 160, 162 (e.g., merchant compute devices, payment processing network compute devices (e.g., credit card payment network devices, digital payments platform compute devices, etc.)), which may interact with account holder compute devices 170, 172 (e.g., through web-based interfaces, native applications, etc.). In some instances, customers may initiate transactions from branch locations (e.g., through interaction with a teller), which communicate with the financial institution 110 using corresponding branch compute devices 180, 182. In other instances, account holders (e.g., customers) may initiate transactions through other payment systems, such as call centers or interactive voice response (IVR) systems.

In operation, the event stream compute device 132 enables compute devices, such as the monitor compute device 120, to receive continual streams of data associated with topics (e.g., identifiers, such as keywords) by subscribing to those streams. In at least some embodiments, the event stream compute device 132 may be implemented in accordance with the event backbone and streaming processor described in U.S. Pat. No. 11,507,438, incorporated by reference herein. The data streams are based on data produced by other compute devices (e.g., one or more transaction processing compute devices 134) and associated with topics on a continual basis as financial transactions are processed. Those data streams, unlike batches in which data is collected and provided to other compute devices on a periodic basis (e.g., nightly, weekly, etc.), are disseminated to other compute devices (e.g., the monitor compute device 120) on an ongoing basis, representing events as they occur. As such, in the illustrative embodiment, the financial transaction data that the monitor compute device 120 obtains from the one or more streams is real-time data (e.g., representative of events as they are occurring).

In operation, the monitor compute device 120 analyzes the obtained financial transaction data (e.g., received in one or more streams) to determine a present condition associated with the financial transactions and provides data indicative of the present condition to one or more users (e.g., personnel associated with the financial institution 110 who may utilize one or more user compute devices 150, 152). In doing so, the monitor compute device 120 may determine whether the present condition is anomalous (e.g., an alert condition), such as by comparing the present condition to a reference condition. The reference condition may be, for example, an average or expected number of transactions for a given time period, for a given geographic region, for a given financial product or payment system (e.g., a channel, such as transactions initiated through online banking, through one or more branches, through an interactive voice response system, etc.), a schedule of payments according to agreed-upon terms for a given financial product, errors, rejections, and/or patterns indicative of fraud, identity theft, and/or hardware or software malfunctions. If the monitor compute device 120 determines that the present condition is indicative of an alert condition, the monitor compute device 120 provides an alert to a user (e.g., employee of the financial institution 110) to enable the user to quickly view data pertaining to the present condition and take a corrective action. In some embodiments, the alert may include a link (e.g., a hyperlink) that, when activated, causes the monitor compute device 120 to filter the financial transaction data to the particular time period, geographic region, payment system (e.g., channel), and/or financial product to which the alert condition pertains. As such, and unlike conventional systems, the system 100 enables the financial institution 110 to quickly identify and respond to anomalies associated with any channel (e.g., payment system), for any financial product, and in any geographic region, as they are developing, to increase the seamlessness, security, and reliability of financial transactions associated with the financial institution 110.

While relatively few compute devices 120, 130, 132, 134, 150, 152, 160, 162, 170, 172, 180, 182 are shown in FIG. 1 for simplicity and clarity, it should be understood that the number of compute devices, in practice, may range in the tens, hundreds, thousands, or more. Likewise, it should be understood that the compute devices 120, 130, 132, 134, 150, 152, 160, 162, 170, 172, 180, 182 may be distributed differently or perform different roles than the configuration shown in FIG. 1. Further, though shown as separate compute devices 120, 130, 132, 134, 150, 152, 160, 162, 170, 172, 180, 182 in some embodiments, the functionality of one or more of the compute devices 120, 130, 132, 134, 150, 152, 160, 162, 170, 172, 180, 182 may be combined into fewer compute devices (the monitor compute device 120 may be combined with the financial institution compute device(s) 130) and/or distributed across more compute devices than those shown in FIG. 1 (e.g., the monitor compute device 120 may comprise multiple compute devices and/or the financial institution compute devices 130 may comprise any number of compute devices).

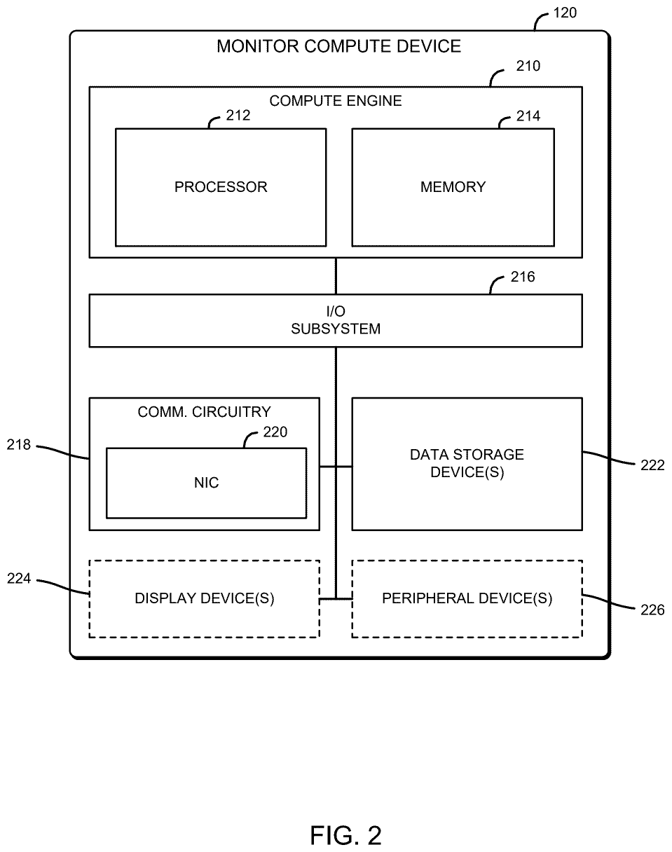

Referring now to FIG. 2, the illustrative monitor compute device 120 includes a compute engine 210, an input/output (I/O) subsystem 216, communication circuitry 218, and one or more data storage devices 222. In some embodiments, the monitor compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the monitor compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as financial transaction data, financial products, payment system data, present condition data, reference condition data, applications, libraries, and drivers.

The compute engine 210 is communicatively coupled to other components of the monitor compute device 120 via the I/O subsystem 216, which may be embodied as circuitry and/or components to facilitate input/output operations with the compute engine 210 (e.g., with the processor 212 and the main memory 214) and other components of the monitor compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the monitor compute device 120, into the compute engine 210.

The communication circuitry 218 may be embodied as any communication circuit, device, or collection thereof, capable of enabling communications over a network between the monitor compute device 120 and another device (e.g., a compute device 130, 132, 134, 150, 152, 160, 162, 170, 172, 180, 182, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the monitor compute device 120 to connect with another compute device (e.g., a compute device 130, 132, 134, 150, 152, 160, 162, 170, 172, 180, 182, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the monitor compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the monitor compute device 120 are housed in a single unit. However, in other embodiments, the components may be in separate housings, in separate racks of a data center, and/or spread across multiple data centers or other facilities. The compute devices 130, 132, 134, 150, 152, 160, 162, 170, 172, 180, 182 may have components similar to those described in FIG. 2 with reference to the monitor compute device 120. The description of those components of the monitor compute device 120 is equally applicable to the description of components of the compute devices 130, 132, 134, 150, 152, 160, 162, 170, 172, 180, 182. Further, it should be appreciated that any of the devices 120, 130, 132, 134, 150, 152, 160, 162, 170, 172, 180, 182 may include other components, sub-components, and devices commonly found in a computing device, which are not discussed above in reference to the monitor compute device 120 and not discussed herein for clarity of the description.

In the illustrative embodiment, the compute devices 120, 130, 132, 134, 150, 152, 160, 162, 170, 172, 180, 182, are in communication via a network 190, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

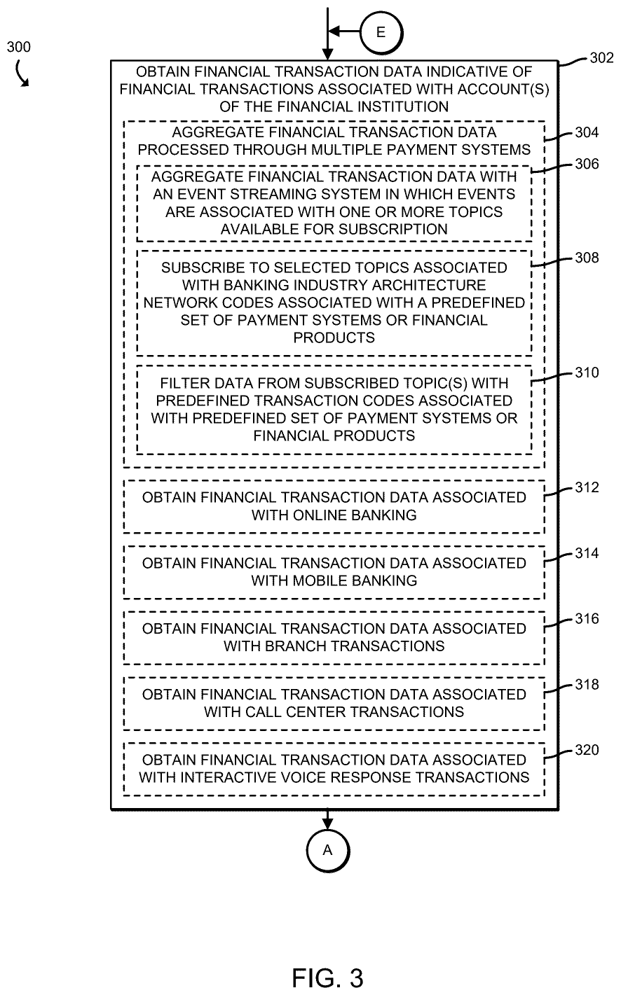

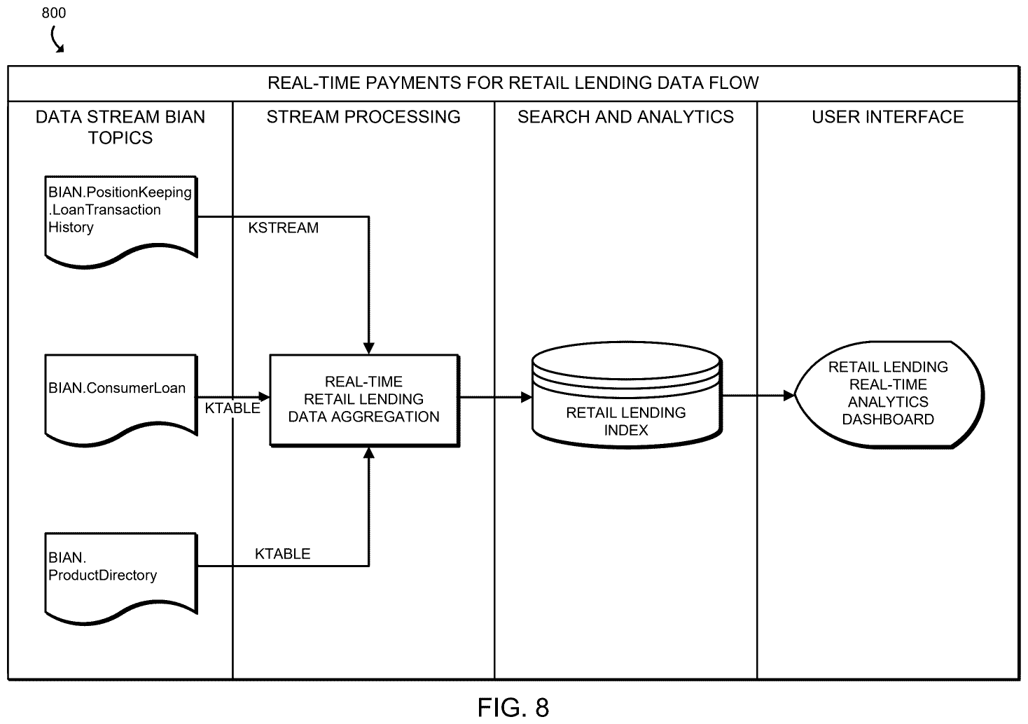

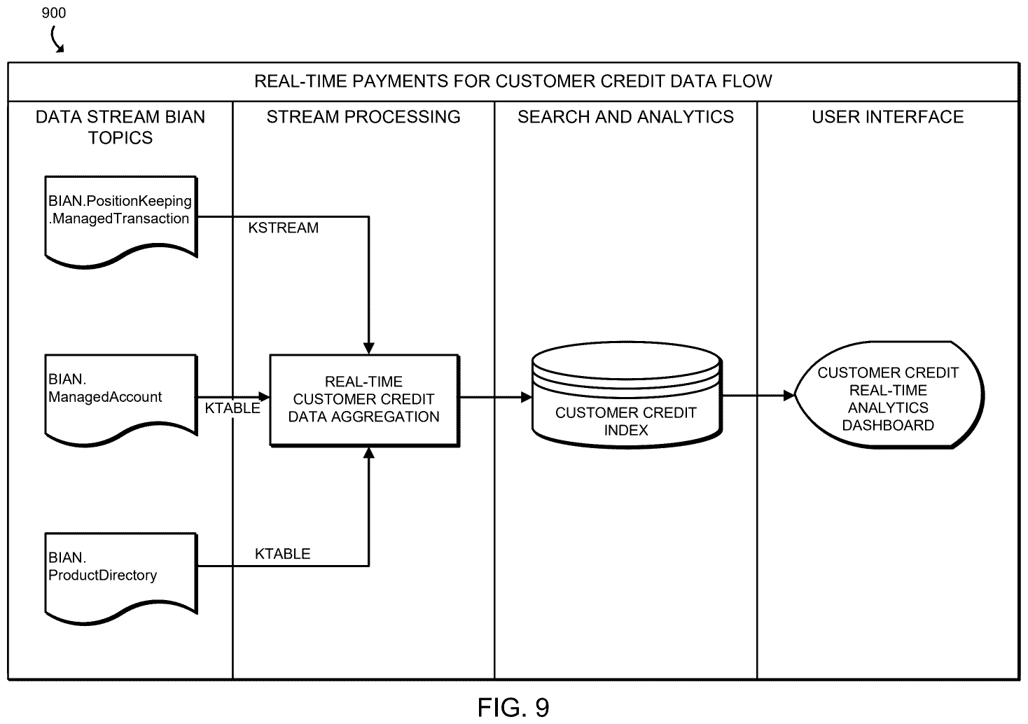

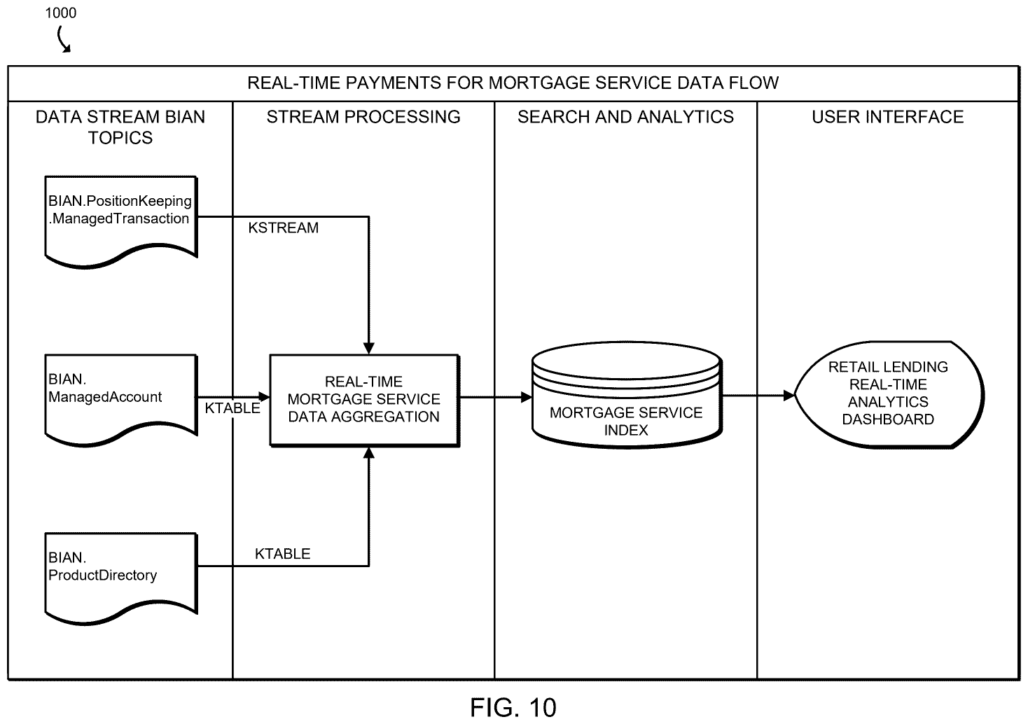

Referring now to FIG. 3, the system 100, and in particular, the monitor compute device 120, in the illustrative embodiment, may perform a method 300 for monitoring financial transactions (e.g., payments) to detect anomalies (e.g., alert conditions). The method 300 begins with block 302 in which the monitor compute device 120 obtains financial transaction data, which may be embodied as any data indicative of financial transactions associated with one or more accounts (e.g., customer accounts) of the financial institution 110. In doing so, and as indicated in block 304, the monitor compute device 120 may aggregated financial transaction data processed through multiple payment systems (e.g., channels). In the illustrative embodiment, the monitor compute device 120 aggregates financial transaction data with (e.g., using) an event streaming system (e.g., the event stream compute device 132) in which events are associated with one or more topics that are available for subscription, as indicated in block 306. The monitor compute device 120 may subscribe to selected topics associated with banking industry architecture network (BIAN) codes associated with a predefined set of payment systems or financial products, as indicated in block 308. For example, and as indicated in the data flow 800 of FIG. 8, for retail lending products, the monitor compute device 120 may subscribe to the following topics for retail lending data: “BIAN.PositionKeeping.LoanTransactionHistory”, “BIAN.ConsumerLoan”, and “BIAN.ProductDirectory”. These topics provide payment transactions, associated accounts, and financial product definition data (e.g., expansive information about what retail lending financial product each account belongs to) respectively. Similarly, in the data flow 900 of FIG. 9, for continual data regarding customer credit financial products, the monitor compute device 120 may subscribe to the following topics: “BIAN.PositionKeeping.ManagedTransaction”, “BIAN.ManagedAccount”, and “BIAN.ProductDirectory” for information about payment transactions, associated accounts, and financial product definition data identifying the specific customer credit related financial product associated with each account. As another example, and as indicated in the data flow 1000 of FIG. 10, the monitor compute device 120 may subscribe to the following topics for ongoing information about financial transactions for mortgage related financial products: “BIAN.PositionKeeping. ManagedTransaction”, “BIAN.ManagedAccount”, and “BIAN.ProductDirectory”, which provide information about the financial transactions, the accounts related to those financial transactions, and information about the financial products related to those accounts, respectively. As described in more detail herein, the monitor compute device 120 processes the aggregated data from the streams, performs analytics on that data, and provides a user interface for presenting analysis results, thereby accounting for the stream processing, search and analytics, and user interface components of the data flows 800, 900, 1000 of FIGS. 8, 9, and 10.

The monitor compute device 120, in the illustrative embodiment, may filter data from the subscribed topics with predefined transaction code associated with predefined sets of payment systems (e.g., channels) or financial products, as indicated in block 310. In the illustrative embodiment, the monitor compute device 120 filters the data streams associated with consumer lending for transaction codes that begin with 63 or 64 or that equal 56020. As indicated in block 312, the monitor compute device 120 may obtain financial transaction data associated with online banking (e.g., transactions initiated based on communications between an account holder compute device 170 and a web-based interface (e.g., a website) to the financial institution compute devices 130). Additionally or alternatively, the monitor compute device 120 may obtain financial transaction data associated with mobile banking (e.g., financial transactions initiated based on communications between an account holder compute device 172 executing a local application designed to make application programming interface (API) calls to one or more of the financial institution compute devices 130), as indicated in block 314.

The monitor compute device 120 may also obtain financial transaction data associated with branch transactions (e.g., transactions initiated from branch compute devices 180, 182 associated with physical branches of the financial institution 110), as indicated in block 316. Additionally or alternatively, the monitor compute device 120 may obtain financial transaction data associated with call center transactions, as indicated in block 318. That is, the monitor compute device 120 may obtain data indicative of financial transactions that were initiated based on phone calls from individuals to one or more call centers associated with the financial institution 110. The monitor compute device 120 may also obtain financial transaction data associated with interactive voice response (IVR) transactions, as indicated in block 320. The operations of call centers and/or IVR systems may be supported by (e.g., executed by) the financial institution compute devices 130 and/or other compute devices of the system 100.

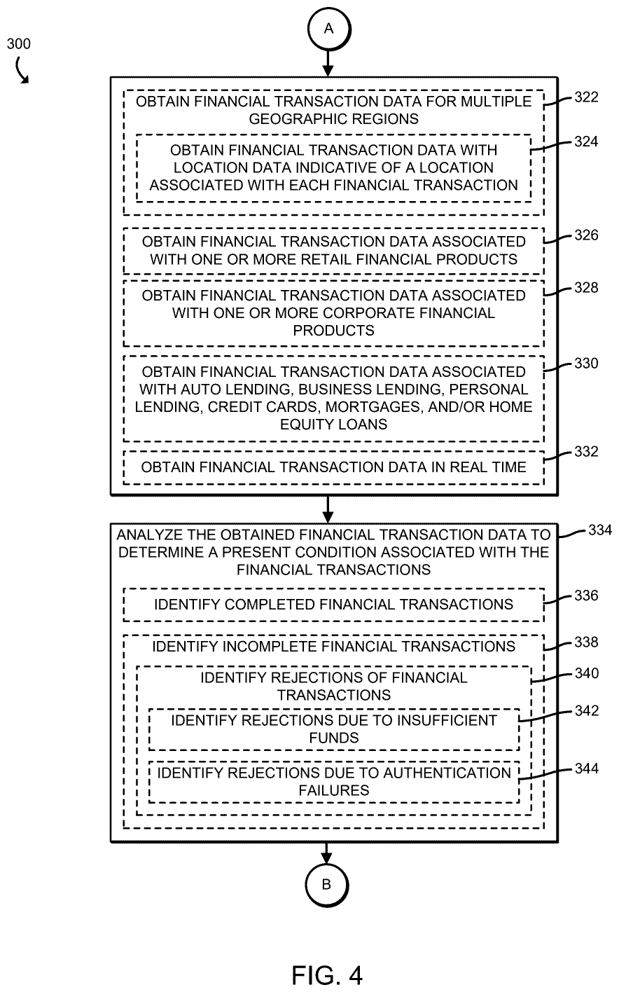

Referring now to FIG. 4, in continuing the method 300, the monitor compute device 120 may obtain financial transaction data for multiple geographic regions, as indicated in block 322. In some embodiments, the monitor compute device 120 may obtain financial transaction data with location data indicative of a location (e.g., a branch identifier, a city identifier, a state identifier, a country identifier, etc.) associated with each financial transaction, as indicated in block 324. As indicated in block 326, the monitor compute device 120 may obtain financial transaction data associated with one or more retail financial products. Additionally or alternatively, the monitor compute device 120 may obtain financial transaction data associated with one or more corporate financial products, as indicated in block 328. In some embodiments, the monitor compute device 120 may obtain financial transaction data associated with one or more of auto lending (e.g., auto loans), business lending, personal lending, credit cards, mortgages, or home equity loans, as indicated in block 330. In the illustrative embodiment, the monitor compute device 120 obtains the financial transaction data in real time (e.g., as the financial transactions occur, rather than in a batch or collection of financial transactions provided on a nightly, weekly, or other periodic basis), as indicated in block 332. As described above, the monitor compute device 120 may obtain the financial transaction data in an ongoing, real time basis because the financial transaction data is provided through one or more data streams (e.g., event streams), as described above.

Afterwards, the method 300 advances to block 334 in which the monitor compute device 120 analyzes the obtained financial transaction data to determine a present condition (e.g., status) associated with the financial transactions. In doing so, in block 336, the monitor compute device 120 may identify completed financial transactions (e.g., as indicated by a corresponding flag or other datum representing completion of the corresponding financial transaction). Similarly, the monitor compute device 120 may identify incomplete financial transactions, as indicated in block 338. In doing so, the monitor compute device 120 may identify rejections of financial transactions, as indicated in block 340. For example, the monitor compute device 120 may identify rejections due to insufficient funds, as indicated in block 342. Additionally or alternatively, the monitor compute device 120 may identify rejections due to authentication failures (e.g., failure of a party to verify their identity), as indicated in block 344. The above reasons for rejection may be indicated by a flag or other data associated with each transaction in a corresponding data stream.

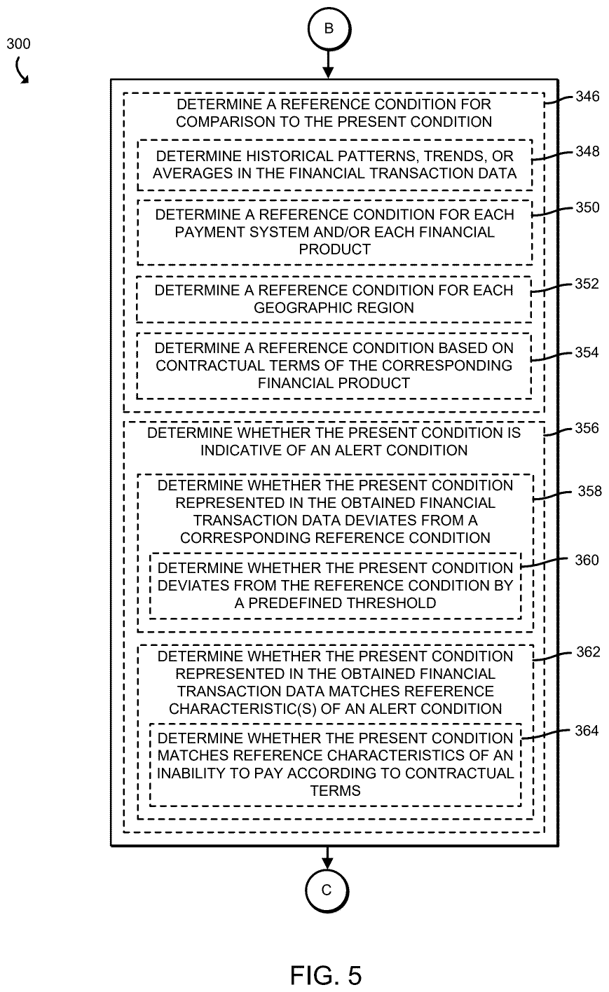

Referring now to FIG. 5, in determining the present condition of the financial transactions, the monitor compute device 120 may determine a reference condition for comparison to the present condition (e.g., to determine whether and how much the present condition differs from the reference condition), as indicated in block 346. In doing so, the monitor compute device 120 may determine one or more historical patterns, trends, or averages in the financial transaction data, as indicated in block 348. That is, each of the patterns, trends, or averages or a combination thereof may represent a reference condition indicative of an expected or normal condition established over a time period (e.g., a week, a month, a year, etc.). As indicated in block 350, the monitor compute device 120 may determine a reference condition for each payment system (e.g., channel) or each financial product associated with the financial institution 110 (e.g., the payment systems and financial products represented in the financial transaction data received through one or more data streams (e.g., from the event stream compute device 132)). Similarly, the monitor compute device 120 may determine a reference condition for each geographic region (e.g., city, state, country, etc.), as indicated in block 352. That is, a relatively populated city may have a significantly higher number of transactions for a particular financial product over a given time period than a relatively unpopulated city. By establishing reference conditions based on geographic regions, the monitor compute device 120 may obtain more granular information for use in comparison to a present condition. Additionally or alternatively, the monitor compute device 120 may determine a reference condition based on contractual terms of a corresponding financial product, as indicated in block 354. For example, the monitor compute device 120 may identify a payment schedule indicating the due dates and monetary amounts for financial transactions (e.g., payments) for a mortgage (e.g., as defined in a database 140, 142) and assign the payment schedule as the reference condition.

Still referring to FIG. 5, the monitor compute device 120, in the illustrative embodiment, determines whether the present condition is indicative of an alert condition (e.g., a status that warrants sending an alert to a human reviewer for further analysis), as indicated in block 356. In doing so, the monitor compute device 120 may determine whether the present condition represented in the obtained financial transaction data deviates from a corresponding reference condition (e.g., a reference condition from block 346), as indicated in block 358. In determining whether the present condition deviates from the reference condition, the monitor compute device 120 may determine whether the present condition deviates from the reference condition by a predefined threshold, such as a predefined percentage (e.g., 5%, 10%, etc.), as indicated in block 360. As indicated in block 362, the monitor compute device 120 may determine whether the present condition represented in the obtained financial transaction data matches (e.g., is within a defined range of) one or more reference characteristics of an alert condition (e.g., whether the present condition is similar to a predefined alert condition). In doing so, and as indicated in block 364, the monitor compute device 120 may determine whether the present condition matches one or more reference characteristics of an inability to pay according to contractual terms, as indicated in block 364. For example, the monitor compute device 120 may determine that payments over the course of a time period have been made increasingly late (e.g., compared to due dates in the payment schedule), which may be indicative of underlying difficulty of a customer in obtaining the funds to make the payments.

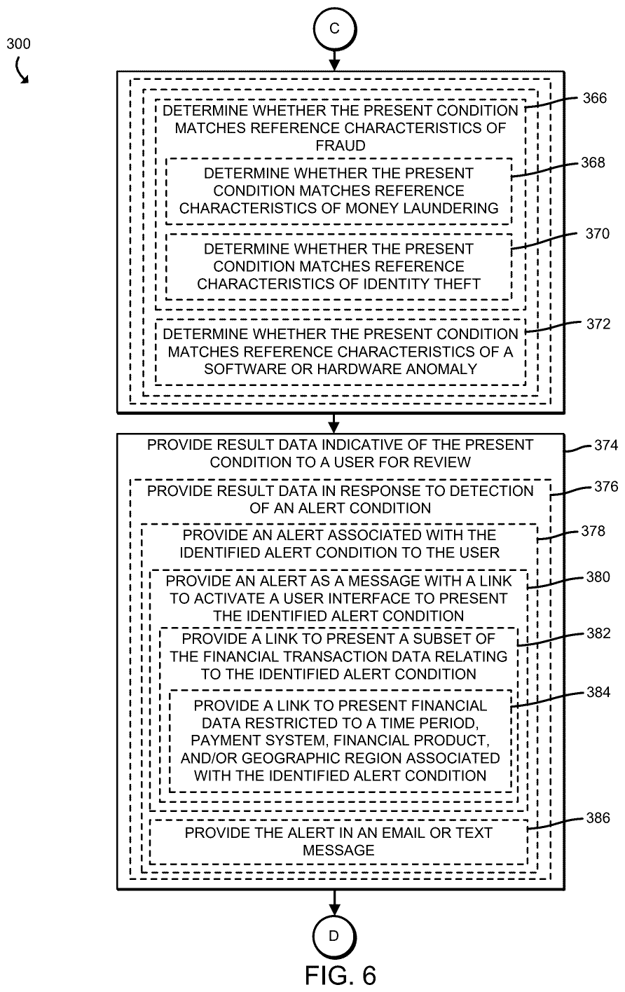

Referring now to FIG. 6, the monitor compute device 120 may determine whether the present condition matches one or more reference characteristics of fraud, as indicated in block 366. In doing so, the monitor compute device 120 may determine whether the present condition matches reference characteristics of money laundering (e.g., placement, layering, and integration), as indicated in block 368. The monitor compute device 120 may determine whether the present condition matches the reference condition matches one or more characteristics of identity theft, as indicated in block 370. For example, the monitor compute device 120 may determine that a pattern exists in which financial transactions associated with an account fail when attempted through one payment system (e.g., call center), but succeed when initiated through another payment system (e.g., online banking). The difference may be due to a person having a stolen password or other login credentials for accessing and initiating transactions through a web site associated with the financial institution 110 but not having sufficient information (e.g., a pin number, an answer to a security question) to authenticate as the customer associated with the financial account when attempting to initiate a transaction through a voice call to a call center associated with the financial institution 110. As indicated in block 372, the monitor compute device 120 may determine whether the present condition matches one or more reference characteristics of a software or hardware anomaly. For example, the monitor compute device 120 may determine that if a trend emerges in which transactions initiated from a particular geographic region are failing to complete, a software or hardware issue may be present in that geographic region (e.g., in the branch compute devices 180, 182 and/or networking equipment located in that geographic region).

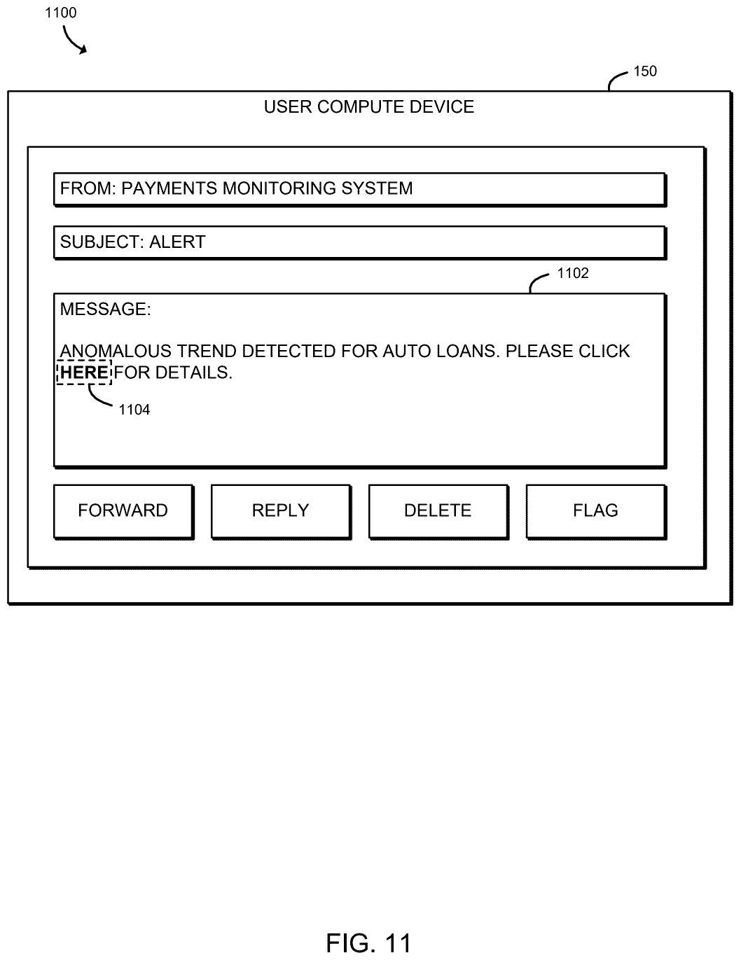

Continuing the method 300, the monitor compute device 120 provides result data, which may be embodied as any data indicative of the present condition, to a user (e.g., a person employed by the financial institution 110 and who operates one or more of the user compute devices 150, 152) for review, as indicated in block 374. The monitor compute device 120 may provide the result data in response to a detection of an alert condition (e.g., a determination that the present condition is indicative of an alert condition by deviating from a reference condition by a threshold amount or by matching one or more reference characteristics of an alert condition, as described above), as indicated in block 376. The monitor compute device 120 may, in block 378, provide an alert associated with the identified alert condition to the user. In doing so, the monitor compute device 120 may provide an alert as a message with a link to activate a user interface to present the identified alert condition, as indicated in block 380. Referring briefly to FIG. 11, an embodiment of a user interface 1100 displayed on a user compute device 150, 152 includes a message 1102 indicative of the alert sent by the monitor compute device 120. The message 1102 includes a link 1104 (e.g., a hyperlink) that when activated (e.g., selected), causes the monitor compute device 120 (e.g., in response to receiving a corresponding request sent by the user compute device 150, 152 in response to a determination that the link 1104 was activated) to provide data defining a user interface to present the identified alert condition.

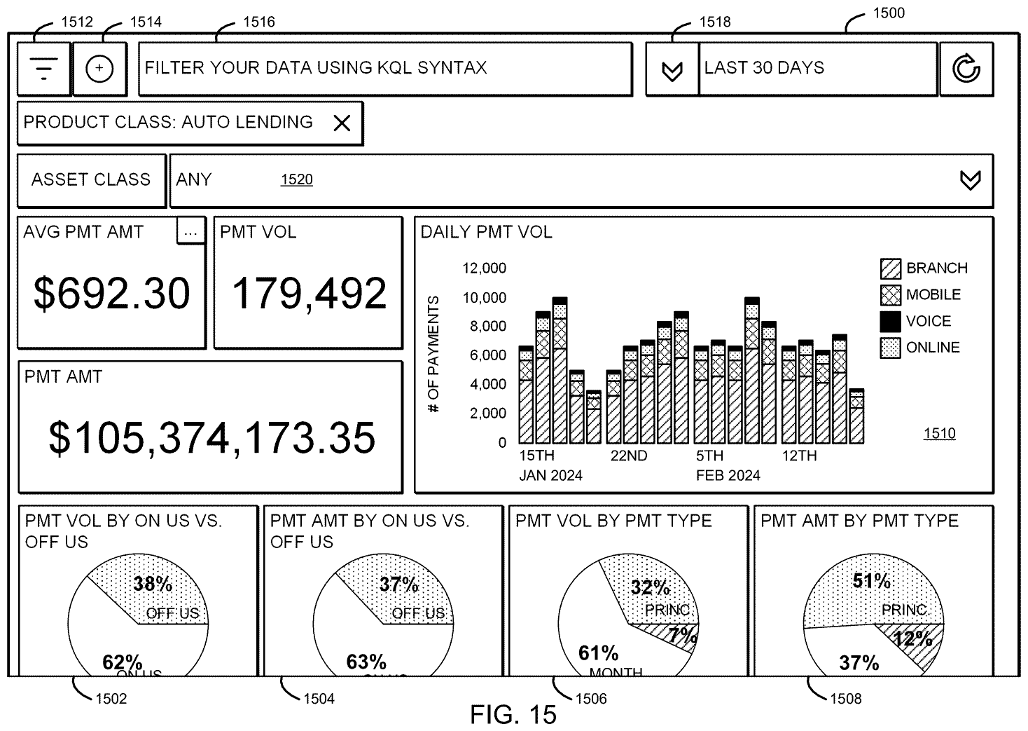

The monitor compute device 120 may provide a link (e.g., the link 1104) that, when activated, causes the monitor compute device 120 to present (e.g., by sending corresponding instructions and/or data to the user compute device 150, 152) a subset of the financial transaction data and in particular, a subset that pertains to the identified alert condition, as indicated in block 382. As indicated in block 384, the monitor compute device 120 may provide a link (e.g., the link 1104) to present (e.g., in a user interface, such as the user interface 1500 of FIG. 15) financial transaction data that is restricted to a time period, payment system (e.g., channel), financial product, and/or geographic region associated with the identified alert condition. Further, and as indicated in block 386, the monitor compute device 120 may provide the alert in an email or text message (e.g., to the user compute device 150, 152).

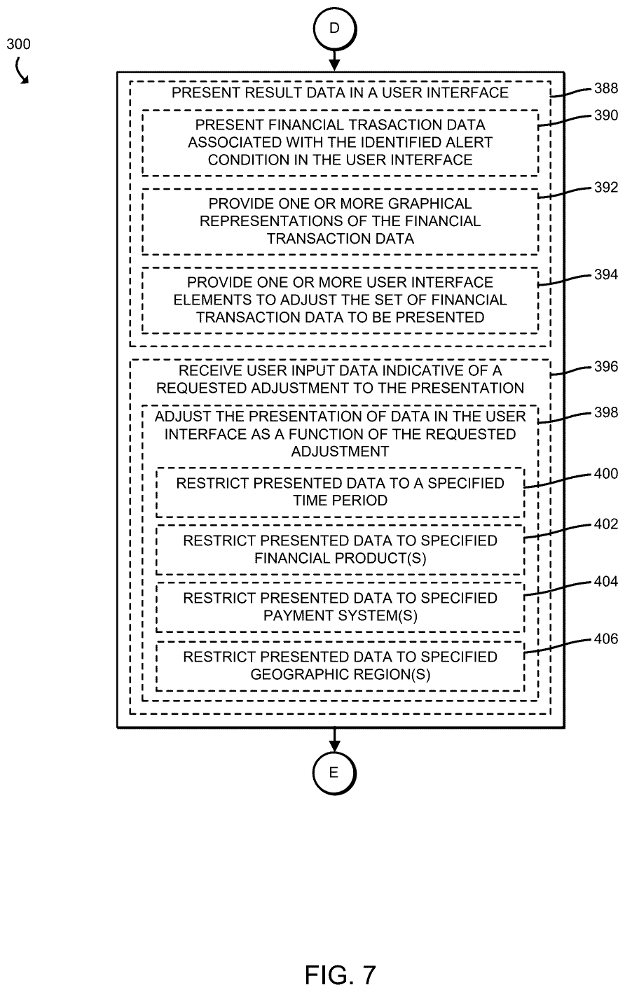

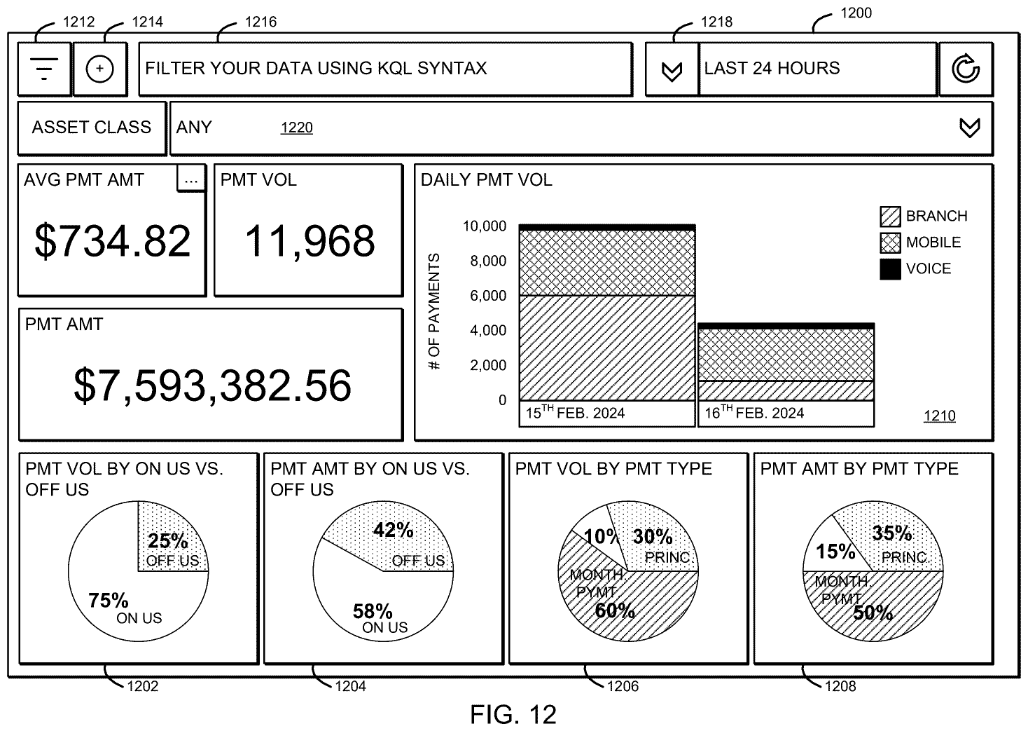

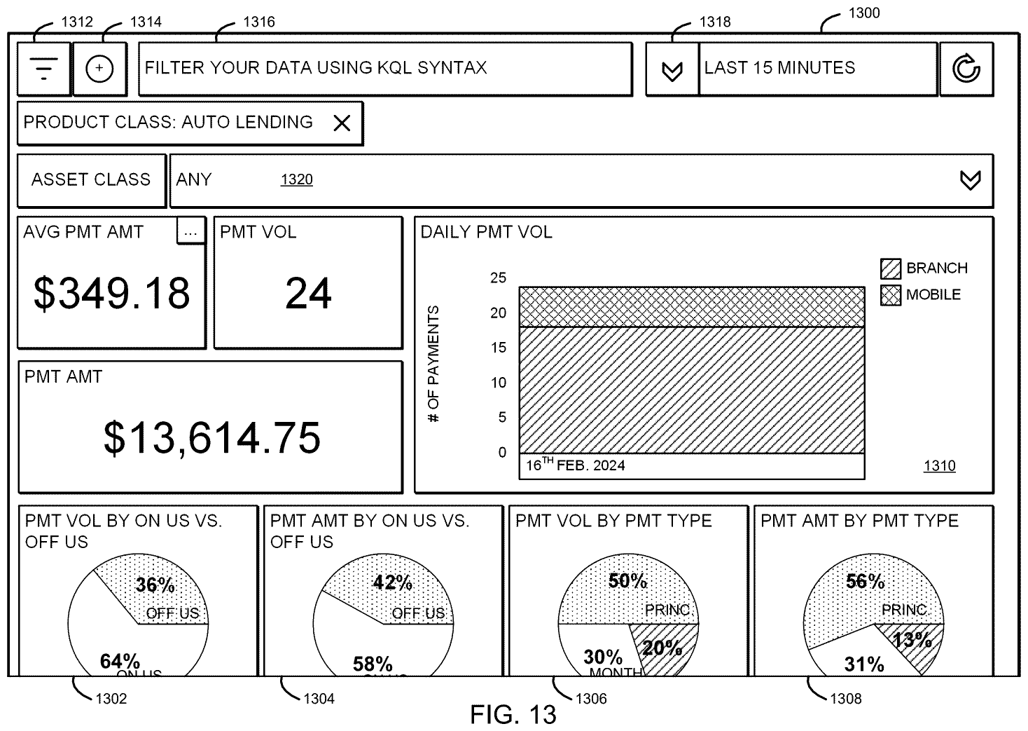

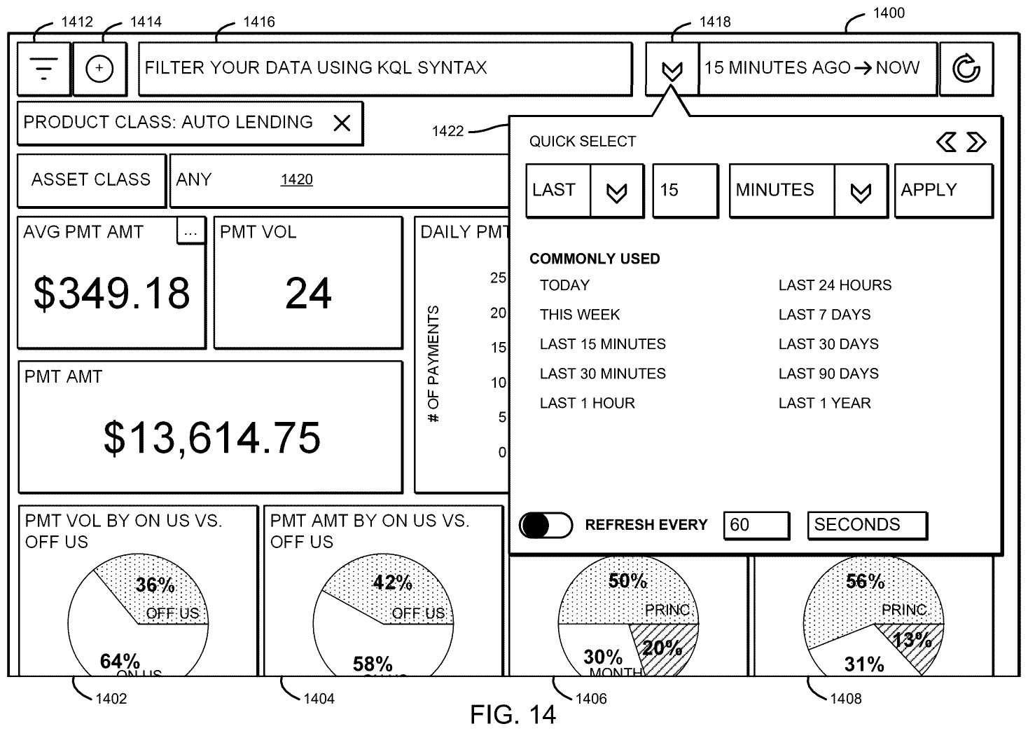

Referring now to FIG. 7, the monitor compute device 120 may present (e.g., by providing corresponding instructions and/or data to display the user interface on a corresponding compute device, such as a user compute device 150, 152) the result data in a user interface, as indicated in block 388. Embodiments of user interfaces 1200, 1300, 1400, 1500 representing result data that may be provided by the monitor compute device 120 are illustrated in FIGS. 12, 13, 14, and 15. In block 390, the monitor compute device 120 may present financial transaction data associated with the identified alert condition in the user interface. As indicated in block 392, the monitor compute device 120 may provide one or more graphical representations of the financial transaction data. For example, the monitor compute device 120 may provide pie charts 1202, 1204, 1206, 1208, 1302, 1304, 1306, 1308, 1402, 1404, 1406, 1408, 1502, 1504, 1506, 1508, bar graphs 1210, 1310, 1510, or other graphical representations that enable efficient user comprehension of the financial transaction data in question. As indicated in block 394, the monitor compute device 120 may provide one or more user interface elements 1212, 1214, 1216, 1218, 1220, 1312, 1314, 1316, 1318, 1320, 1410, 1412, 1414, 1416, 1418, 1420, 1422, 1512, 1514, 1516, 1518, 1520 (e.g., menus, toggles, buttons, query text boxes, etc.) to adjust the set of financial transaction data to be presented.

The monitor compute device 120 may receive user input data indicative of a requested adjustment to the presentation, as indicated in block 396. In response, the monitor compute device 120 may adjust the presentation of data in the user interface as a function of (e.g., based on) the requested adjustment, as indicated in block 398. In doing so, the monitor compute device 120 may restrict the presented data to a specified time period, as indicated in block 400. Additionally or alternatively, the monitor compute device 120 may restrict the presented data to one or more specified financial products, as indicated in block 402. The monitor compute device 120 may restrict the presented data to data pertaining to a specified set of payment systems (e.g., channels), as indicated in block 404. Additionally or alternatively, the monitor compute device 120 may restrict the presented data to one or more specified geographic regions, as indicated in block 406. Specifically, in some embodiments, in response to detecting a change in the state of a user interface element 1212, 1214, 1216, 1218, 1220, 1312, 1314, 1316, 1318, 1320, 1410, 1412, 1414, 1416, 1418, 1420, 1422, 1512, 1514, 1516, 1518, 1520, the user compute device 150, 152 may send a request (e.g., using a corresponding application programming interface call, such as a representation state transfer (REST) request) to the monitor compute device 120 indicative of the requested data (e.g., a change to the time period, a filter to be applied to the financial product, etc.) and the monitor compute device 120 may provide the requested data (e.g., in a REST response) to the user compute device 150, 152 for presentation. As an example, the user interface 1200 presents data indicative of completed payments for consumer lending products over a 24 hour period. In the user interface 1300, the presented data has been adjusted in that the financial product has been restricted to auto lending products (e.g., loans for vehicles) and the applicable time period has been reduced to 15 minutes. The user interface 1400 presents a quick select menu 1422 to receive user input to adjust the applicable time period (e.g., for data pertaining to completed payments for auto lending products). Further, the user interface 1500 represents an adjusted presentation focused on a user specified time period (e.g., 30 days, as selected in the user interface 1400).

In the illustrative embodiment, the method 300 loops back to block 302 of FIG. 3 to obtain additional financial transaction data. Though the operations of the method 300 are described in a particular sequence, it should be understood that in other embodiments, operations may be performed in a different order and/or in parallel (e.g., obtaining additional financial transaction data while detecting an alert condition in the already-obtained financial transaction data). While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain, by subscribing to at least one topic of an event streaming system associated with a predefined set of payment systems or financial products, financial transaction data indicative of financial transactions associated with one or more accounts of a financial institution; analyze the obtained financial transaction data to determine a present condition associated with the financial transactions; and provide result data indicative of the present condition to a user for review.

Example 2 includes the subject matter of Example 1, and wherein to obtain financial transaction data comprises to subscribe to at least one topic in the event stream associated with a banking industry architecture network code.

Example 3 includes the subject matter of any of Examples 1 and 2, and wherein the circuitry is further configured to filter, with a predefined transaction code, financial transaction data associated with the at least one topic.

Example 4 includes the subject matter of any of Examples 1-3, and wherein to obtain financial transaction data comprises to obtain financial transaction data in real time.

Example 5 includes the subject matter of any of Examples 1-4, and wherein to obtain financial transaction data comprises to obtain financial transaction data associated with online banking.

Example 6 includes the subject matter of any of Examples 1-5, and wherein to obtain financial transaction data comprises to obtain financial transaction data associated with mobile banking.

Example 7 includes the subject matter of any of Examples 1-6, and wherein to obtain financial transaction data comprises to obtain financial transaction data associated with one or more branches of the financial institution.

Example 8 includes the subject matter of any of Examples 1-7, and wherein to obtain financial transaction data comprises to obtain financial transaction data associated with a call center of the financial institution.

Example 9 includes the subject matter of any of Examples 1-8, and wherein to obtain financial transaction data comprises to obtain financial transaction data associated with an interactive voice response system of the financial institution.

Example 10 includes the subject matter of any of Examples 1-9, and wherein to obtain financial transaction data comprises to obtain financial transaction data for multiple geographic regions.

Example 11 includes the subject matter of any of Examples 1-10, and wherein to obtain financial transaction data comprises to obtain financial transaction data associated with one or more retail financial products or corporate financial products.

Example 12 includes the subject matter of any of Examples 1-11, and wherein to obtain financial transaction data comprises to obtain financial transaction data associated with one or more of auto lending, business lending, personal lending, credit cards, mortgages, or home equity loans.

Example 13 includes the subject matter of any of Examples 1-12, and wherein to analyze the obtained financial transaction data comprises to identify completed financial transactions and financial transactions that have not been completed.

Example 14 includes the subject matter of any of Examples 1-13, and wherein the circuitry is further configured to identify rejections of financial transactions due to insufficient funds.

Example 15 includes the subject matter of any of Examples 1-14, and wherein the circuitry is further configured to identify rejections of financial transactions due to authentication failures.

Example 16 includes the subject matter of any of Examples 1-15, and wherein the circuitry is further configured to determine whether the present condition is indicative of an alert condition; and provide, in response to a determination that the present condition is indicative of an alert condition, an alert to the user.

Example 17 includes the subject matter of any of Examples 1-16, and wherein to determine whether the present condition is indicative of an alert condition comprises to determine a reference condition for comparison to the present condition; and determine whether the present condition deviates from the reference condition by a predefined threshold.

Example 18 includes the subject matter of any of Examples 1-17, and wherein to determine a reference condition comprises to determine a historical pattern, trend, or average in the financial transaction data in association with one or more of a payment system, a financial product, or a geographic region.

Example 19 includes the subject matter of any of Examples 1-18, and wherein to determine a reference condition comprises to determine the reference condition based on one or more contractual terms for a financial product associated with the financial transaction data.

Example 20 includes the subject matter of any of Examples 1-19, and wherein to determine whether the present condition is indicative of an alert condition comprises to determine whether the present condition has one or more characteristics of an alert condition.

Example 21 includes the subject matter of any of Examples 1-20, and wherein to determine whether the present condition has one or more characteristics of an alert condition comprises to determine whether the present condition has one or more characteristics of an inability to pay according to contractual terms, fraud, a software anomaly, or a hardware anomaly.

Example 22 includes the subject matter of any of Examples 1-21, and wherein to provide an alert comprises to provide a message with a link to activate a user interface to present the identified alert condition to the user.

Example 23 includes the subject matter of any of Examples 1-22, and wherein to provide a message with a link comprises to provide a link to present financial transaction data restricted to at least one of a time period, a payment system, a financial product, or a geographic region associated with the alert condition.

Example 24 includes the subject matter of any of Examples 1-23, and wherein to provide a message with a link comprises to provide the message as an email or text message.

Example 25 includes the subject matter of any of Examples 1-24, and wherein the circuitry is further configured to present the financial transaction data in a user interface.

Example 26 includes the subject matter of any of Examples 1-25, and wherein the circuitry is further configured to provide one or more graphical representations of the financial transaction data.

Example 27 includes the subject matter of any of Examples 1-26, and wherein the circuitry is further configured to present the financial transaction data in a user interface that includes one or more user interface elements to request an adjustment to a presentation of the financial transaction data; receive user input data indicative of a requested adjustment to the presentation; and adjust the presentation in the user interface as a function of the requested adjustment.

Example 28 includes the subject matter of any of Examples 1-27, and wherein to adjust the presentation comprises to restrict the presentation to one or more of a specified time period, a set of one or more financial products, a set of one or more payment systems, or one or more specified geographic regions.

Example 29 includes a method comprising obtaining, by a compute device and by subscribing to at least one topic of an event streaming system associated with a predefined set of payment systems or financial products, financial transaction data indicative of financial transactions associated with one or more accounts of a financial institution; analyzing, by the compute device, the obtained financial transaction data to determine a present condition associated with the financial transactions; and providing, by the compute device, result data indicative of the present condition to a user for review.

Example 30 includes the subject matter of Example 29, and wherein obtaining financial transaction data comprises subscribing to at least one topic in the event stream associated with a banking industry architecture network code.

Example 31 includes the subject matter of any of Examples 29 and 30, and further including filtering, by the compute device and with a predefined transaction code, financial transaction data associated with the at least one topic.

Example 32 includes the subject matter of any of Examples 29-31, and wherein obtaining financial transaction data comprises obtaining financial transaction data in real time.

Example 33 includes the subject matter of any of Examples 29-32, and wherein obtaining financial transaction data comprises obtaining financial transaction data associated with online banking.

Example 34 includes the subject matter of any of Examples 29-33, and wherein obtaining financial transaction data comprises obtaining financial transaction data associated with mobile banking.

Example 35 includes the subject matter of any of Examples 29-34, and wherein obtaining financial transaction data comprises obtaining financial transaction data associated with one or more branches of the financial institution.

Example 36 includes the subject matter of any of Examples 29-35, and wherein obtaining financial transaction data comprises obtaining financial transaction data associated with a call center of the financial institution.

Example 37 includes the subject matter of any of Examples 29-36, and wherein obtaining financial transaction data comprises obtaining financial transaction data associated with an interactive voice response system of the financial institution.

Example 38 includes the subject matter of any of Examples 29-37, and wherein obtaining financial transaction data comprises obtaining financial transaction data for multiple geographic regions.

Example 39 includes the subject matter of any of Examples 29-38, and wherein obtaining financial transaction data comprises obtaining financial transaction data associated with one or more retail financial products or corporate financial products.

Example 40 includes the subject matter of any of Examples 29-39, and wherein obtaining financial transaction data comprises obtaining financial transaction data associated with one or more of auto lending, business lending, personal lending, credit cards, mortgages, or home equity loans.

Example 41 includes the subject matter of any of Examples 29-40, and wherein analyzing the obtained financial transaction data comprises identifying completed financial transactions and financial transactions that have not been completed.

Example 42 includes the subject matter of any of Examples 29-41, and further including identifying, by the compute device, rejections of financial transactions due to insufficient funds.

Example 43 includes the subject matter of any of Examples 29-42, and further including identifying, by the compute device, rejections of financial transactions due to authentication failures.

Example 44 includes the subject matter of any of Examples 29-43, and further including determining, by the compute device, whether the present condition is indicative of an alert condition; and providing, by the compute device and in response to a determination that the present condition is indicative of an alert condition, an alert to the user.

Example 45 includes the subject matter of any of Examples 29-44, and wherein determining whether the present condition is indicative of an alert condition comprises determining a reference condition for comparison to the present condition; and determining whether the present condition deviates from the reference condition by a predefined threshold.

Example 46 includes the subject matter of any of Examples 29-45, and wherein determining a reference condition comprises determining a historical pattern, trend, or average in the financial transaction data in association with one or more of a payment system, a financial product, or a geographic region.

Example 47 includes the subject matter of any of Examples 29-46, and wherein determining a reference condition comprises determining the reference condition based on one or more contractual terms for a financial product associated with the financial transaction data.

Example 48 includes the subject matter of any of Examples 29-47, and wherein determining whether the present condition is indicative of an alert condition comprises determining whether the present condition has one or more characteristics of an alert condition.

Example 49 includes the subject matter of any of Examples 29-48, and wherein determining whether the present condition has one or more characteristics of an alert condition comprises determining whether the present condition has one or more characteristics of an inability to pay according to contractual terms, fraud, a software anomaly, or a hardware anomaly.

Example 50 includes the subject matter of any of Examples 29-49, and wherein providing an alert comprises providing a message with a link to activate a user interface to present the identified alert condition to the user.

Example 51 includes the subject matter of any of Examples 29-50, and wherein providing a message with a link comprises providing a link to present financial transaction data restricted to at least one of a time period, a payment system, a financial product, or a geographic region associated with the alert condition.

Example 52 includes the subject matter of any of Examples 29-51, and wherein providing a message with a link comprises providing the message as an email or text message.

Example 53 includes the subject matter of any of Examples 29-52, and further including presenting the financial transaction data in a user interface.

Example 54 includes the subject matter of any of Examples 29-53, and further including providing one or more graphical representations of the financial transaction data.

Example 55 includes the subject matter of any of Examples 29-54, and further including presenting, by the compute device, the financial transaction data in a user interface that includes one or more user interface elements to request an adjustment to a presentation of the financial transaction data; receiving, by the compute device, user input data indicative of a requested adjustment to the presentation; and adjusting, by the compute device, the presentation in the user interface as a function of the requested adjustment.

Example 56 includes the subject matter of any of Examples 29-55, and wherein adjusting the presentation comprises restricting the presentation to one or more of a specified time period, a set of one or more financial products, a set of one or more payment systems, or one or more specified geographic regions.

Example 57 includes one or more machine-readable storage media comprising a plurality of instructions stored thereon that, in response to being executed, cause a compute device to obtain, by subscribing to at least one topic of an event streaming system associated with a predefined set of payment systems or financial products, financial transaction data indicative of financial transactions associated with one or more accounts of a financial institution; analyze the obtained financial transaction data to determine a present condition associated with the financial transactions; and provide result data indicative of the present condition to a user for review.

Example 58 includes the subject matter of Example 57, and wherein to obtain financial transaction data comprises to subscribe to at least one topic in the event stream associated with a banking industry architecture network code.

Example 59 includes the subject matter of any of Examples 57 and 58, and wherein the instructions additionally cause the compute device to filter, with a predefined transaction code, financial transaction data associated with the at least one topic.

Example 60 includes the subject matter of any of Examples 57-59, and wherein to obtain financial transaction data comprises to obtain financial transaction data in real time.

Example 61 includes the subject matter of any of Examples 57-60, and wherein to obtain financial transaction data comprises to obtain financial transaction data associated with online banking.

Example 62 includes the subject matter of any of Examples 57-61, and wherein to obtain financial transaction data comprises to obtain financial transaction data associated with mobile banking.

Example 63 includes the subject matter of any of Examples 57-62, and wherein to obtain financial transaction data comprises to obtain financial transaction data associated with one or more branches of the financial institution.

Example 64 includes the subject matter of any of Examples 57-63, and wherein to obtain financial transaction data comprises to obtain financial transaction data associated with a call center of the financial institution.

Example 65 includes the subject matter of any of Examples 57-64, and wherein to obtain financial transaction data comprises to obtain financial transaction data associated with an interactive voice response system of the financial institution.

Example 66 includes the subject matter of any of Examples 57-65, and wherein to obtain financial transaction data comprises to obtain financial transaction data for multiple geographic regions.

Example 67 includes the subject matter of any of Examples 57-66, and wherein to obtain financial transaction data comprises to obtain financial transaction data associated with one or more retail financial products or corporate financial products.

Example 68 includes the subject matter of any of Examples 57-67, and wherein to obtain financial transaction data comprises to obtain financial transaction data associated with one or more of auto lending, business lending, personal lending, credit cards, mortgages, or home equity loans.

Example 69 includes the subject matter of any of Examples 57-68, and wherein to analyze the obtained financial transaction data comprises to identify completed financial transactions and financial transactions that have not been completed.

Example 70 includes the subject matter of any of Examples 57-69, and wherein the instructions additionally cause the compute device to identify rejections of financial transactions due to insufficient funds.

Example 71 includes the subject matter of any of Examples 57-70, and wherein the instructions additionally cause the compute device to identify rejections of financial transactions due to authentication failures.

Example 72 includes the subject matter of any of Examples 57-71, and wherein the instructions additionally cause the compute device to determine whether the present condition is indicative of an alert condition; and provide, in response to a determination that the present condition is indicative of an alert condition, an alert to the user.

Example 73 includes the subject matter of any of Examples 57-72, and wherein to determine whether the present condition is indicative of an alert condition comprises to determine a reference condition for comparison to the present condition; and determine whether the present condition deviates from the reference condition by a predefined threshold.

Example 74 includes the subject matter of any of Examples 57-73, and wherein to determine a reference condition comprises to determine a historical pattern, trend, or average in the financial transaction data in association with one or more of a payment system, a financial product, or a geographic region.

Example 75 includes the subject matter of any of Examples 57-74, and wherein to determine a reference condition comprises to determine the reference condition based on one or more contractual terms for a financial product associated with the financial transaction data.

Example 76 includes the subject matter of any of Examples 57-75, and wherein to determine whether the present condition is indicative of an alert condition comprises to determine whether the present condition has one or more characteristics of an alert condition.

Example 77 includes the subject matter of any of Examples 57-76, and wherein to determine whether the present condition has one or more characteristics of an alert condition comprises to determine whether the present condition has one or more characteristics of an inability to pay according to contractual terms, fraud, a software anomaly, or a hardware anomaly.

Example 78 includes the subject matter of any of Examples 57-77, and wherein to provide an alert comprises to provide a message with a link to activate a user interface to present the identified alert condition to the user.

Example 79 includes the subject matter of any of Examples 57-78, and wherein to provide a message with a link comprises to provide a link to present financial transaction data restricted to at least one of a time period, a payment system, a financial product, or a geographic region associated with the alert condition.

Example 80 includes the subject matter of any of Examples 57-79, and wherein to provide a message with a link comprises to provide the message as an email or text message.

Example 81 includes the subject matter of any of Examples 57-80, and wherein the instructions additionally cause the compute device to present the financial transaction data in a user interface.

Example 82 includes the subject matter of any of Examples 57-81, and wherein the instructions additionally cause the compute device to provide one or more graphical representations of the financial transaction data.

Example 83 includes the subject matter of any of Examples 57-82, and wherein the instructions additionally cause the compute device to present the financial transaction data in a user interface that includes one or more user interface elements to request an adjustment to a presentation of the financial transaction data; receive user input data indicative of a requested adjustment to the presentation; and adjust the presentation in the user interface as a function of the requested adjustment.

Example 84 includes the subject matter of any of Examples 57-83, and wherein to adjust the presentation comprises to restrict the presentation to one or more of a specified time period, a set of one or more financial products, a set of one or more payment systems, or one or more specified geographic regions.

1. A compute device comprising:
circuitry configured to:
obtain, by subscribing to at least one topic of an event streaming system associated with a predefined set of payment systems or financial products, financial transaction data indicative of financial transactions associated with one or more accounts of a financial institution;
analyze the obtained financial transaction data to determine a present condition associated with the financial transactions; and
provide result data indicative of the present condition to a user for review.

2. The compute device of claim 1, wherein to obtain financial transaction data comprises to subscribe to at least one topic in the event stream associated with a banking industry architecture network code.

3. The compute device of claim 2, wherein the circuitry is further configured to filter, with a predefined transaction code, financial transaction data associated with the at least one topic.

4. The compute device of claim 1, wherein to analyze the obtained financial transaction data comprises to identify completed financial transactions and financial transactions that have not been completed.

5. The compute device of claim 4, wherein the circuitry is further configured to identify rejections of financial transactions due to one or more of (i) insufficient funds and/or (ii) authentication failures.

6. The compute device of claim 4, wherein the circuitry is further configured to:
determine whether the present condition is indicative of an alert condition; and
provide, in response to a determination that the present condition is indicative of an alert condition, an alert to the user.

7. The compute device of claim 6, wherein to determine whether the present condition is indicative of an alert condition comprises to:
determine a reference condition for comparison to the present condition; and
determine whether the present condition deviates from the reference condition by a predefined threshold.

8. The compute device of claim 7, wherein to determine a reference condition comprises to determine: (i) a historical pattern, trend, or average in the financial transaction data in association with one or more of a payment system, a financial product, or a geographic region; and/or (ii) the reference condition based on one or more contractual terms for a financial product associated with the financial transaction data.

9. The compute device of claim 7, wherein to determine whether the present condition is indicative of an alert condition comprises to determine whether the present condition has one or more characteristics of (i) an alert condition; and/or (ii) an inability to pay according to contractual terms, fraud, a software anomaly, or a hardware anomaly.

10. The compute device of claim 7, wherein to provide an alert comprises to provide a message with a link to activate a user interface to present the identified alert condition to the user.

11. The compute device of claim 10, wherein to provide a message with a link comprises to provide: (i) a link to present financial transaction data restricted to at least one of a time period, a payment system, a financial product, or a geographic region associated with the alert condition; and/or (ii) a message with a link comprises to provide the message as an email or text message.

12. The compute device of claim 1, wherein the circuitry is further configured to:
present the financial transaction data in a user interface that includes one or more user interface elements to request an adjustment to a presentation of the financial transaction data;
receive user input data indicative of a requested adjustment to the presentation; and
adjust the presentation in the user interface as a function of the requested adjusment.

13. The compute device of claim 12, wherein to adjust the presentation comprises to restrict the presentation to one or more of a specified time period, a set of one or more financial products, a set of one or more payment systems, or one or more specified geographic regions.

14. A method comprising:
obtaining, by a compute device and by subscribing to at least one topic of an event streaming system associated with a predefined set of payment systems or financial products, financial transaction data indicative of financial transactions associated with one or more accounts of a financial institution;
analyzing, by a compute device, the obtained financial transaction data to determine a present condition associated with the financial transactions; and
providing, by a compute device, result data indicative of the present condition to a user for review.

15. The method of claim 14, wherein obtaining financial transaction data comprises to subscribe to at least one topic in the event stream associated with a banking industry architecture network code.

16. The method of claim 15, further comprising filtering, with a predefined transaction code, financial transaction data associated with the at least one topic.

17. The method of claim 14, wherein analyzing the obtained financial transaction data comprises to identify completed financial transactions and financial transactions that have not been completed.

18. The method of claim 17, further comprising identifying rejections of financial transactions due to one or more of (i) insufficient funds and/or (ii) authentication failures.

19. The method of claim 17, further comprising:
determining whether the present condition is indicative of an alert condition; and
providing, in response to a determination that the present condition is indicative of an alert condition, an alert to the user.

20. The method of claim 19, wherein determining whether the present condition is indicative of an alert condition comprises:
determining a reference condition for comparison to the present condition; and
determining whether the present condition deviates from the reference condition by a predefined threshold.

21. The method of claim 20, wherein determining a reference condition comprises determining: (i) a historical pattern, trend, or average in the financial transaction data in association with one or more of a payment system, a financial product, or a geographic region; and/or (ii) the reference condition based on one or more contractual terms for a financial product associated with the financial transaction data.

22. The method of claim 20, wherein determining whether the present condition is indicative of an alert condition comprises determining whether the present condition has one or more characteristics of (i) an alert condition; and/or (ii) an inability to pay according to contractual terms, fraud, a software anomaly, or a hardware anomaly.

23. The method of claim 20, wherein providing an alert comprises providing a message with a link to activate a user interface to present the identified alert condition to the user.

24. The method of claim 23, wherein providing a message with a link comprises providing: (i) a link to present financial transaction data restricted to at least one of a time period, a payment system, a financial product, or a geographic region associated with the alert condition; and/or (ii) a message with a link comprises to provide the message as an email or text message.

25. The method of claim 14, further comprising:
presenting the financial transaction data in a user interface that includes one or more user interface elements to request an adjustment to a presentation of the financial transaction data;
receiving user input data indicative of a requested adjustment to the presentation; and
adjusting the presentation in the user interface as a function of the requested adjusment.

26. The method of claim 25, wherein adjusting the presentation comprises restricting the presentation to one or more of a specified time period, a set of one or more financial products, a set of one or more payment systems, or one or more specified geographic regions.
